(19) United States
(12) Patent Application Publication
(10) Pub. No.: US 2003/0073939 A1
(43) Pub. Date: Apr. 17, 2003

(54) Continuous passive motion apparatus

(76) Inventors: Robin L. Taylor, Grove City, OH (US); Lloyd E. McNutt, Grove City, OH (US)

Correspondence Address: Sean M. Casey, Sean M. Casey Co., L.P.A., P.O. Box 710, New Albany, OH, 43054-0710, US

(21) Appl. No.: 09/792,298

(22) Filed: Feb. 23, 2001

(51) Int. Cl. A61H 1/00

(52) U.S. Cl. 601/40

(57) ABSTRACT

A continuous passive motion apparatus for therapeutic treatment of the fingers of a patient's hand that includes a forearm hand splint. A drive unit is mounted on a palmer aspect of the splint and incorporates a motorized drive tube actuatable over a selectable range of motion. A flexion and extension assembly is connected to the tube and includes at least one finger motion assembly. The finger motion assembly is pivotally interconnected to a proximal end of the drive tube by a coupler adapted to enable movement in at least 2 degrees of freedom relative to the coupler. The coupler is further adapted to releasably engage the at least one finger motion assembly after adjustment to optimally accommodate the anatomical arrangement, size, and range and path of motion of the fingers. The finger motion assembly includes a resilient prime mover selected to be repeatedly bendable without damage but with a bend memory so that it can be adjusted to have an angle of up to about 90 degrees. In variations of the exemplary embodiment, the prime mover is interconnected to the coupler by at least one pivot ball received within the coupler and configured to move about multiple axes of motion. At least one finger splint is releasably connected to a distal end of the finger motion assembly and is adapted to receive a distal phalanx of the finger. The finger splint is preferably formed from a flexible sheet material that incorporates one or more stiffening, bend memory, and hypo-allergenic adhesive layers.

### TECHNICAL FIELD

This invention relates to a continuous passive motion apparatus for therapeutic treatment of a patient by mobilization of traumatized tissue.

### BACKGROUND OF THE INVENTION

In the medical and physical therapy fields, it has in recent years been shown that the past methods of immobilization of biological tissues during the healing process can be detrimental in certain circumstances. The lack of stimulation and movement during the healing process has been found to allow or even induce swelling due to undesirable fluid accumulation in the tissue, and to allow the formation of various types of what is commonly referred to scar tissue. While active motion of traumatized tissues by a patient may be contraindicated, there are specific situations where motion may be desirable. For example, recent studies have shown that the healing of traumatized biological tissue can be significantly improved in some circumstances by the periodic, intermittent, and sometimes continuous stimulation and constrained motion of the traumatized tissue during the healing process, which, among other notable benefits, can reduce the recovery time.

The discovery of the benefits of therapeutic, continuous passive motion hereafter referred to as “CPM”) may have been recognized as early as the late 1970's and early 1980's. The work of Dr. Robert B. Salter, a one-time Professor and Head of Orthopaedic Surgery at the University of Toronto, Canada, and Senior Orthopaedic Surgeon at the Hospital for Sick Children in Toronto, is recognized as having been among the first to incorporate the therapeutic benefits of CPM. Dr. Salter has been credited with having coined the expression “continuous passive motion” and some of his work is described in an article entitled “Joints Were Meant to Move—And Move Again” by Ohlendorf in The Graduate, published by The Department of Information Services, University of Toronto, September/October 1980.

The use of CPM has been found to reduce postoperative pain, swelling, and accumulation of fluids, to maintain a good range of motion in corporeal joints and supporting cartilage, tendons, muscles, and related tissues, to prevent extra-articular contractures and intra-articular adhesions, and to improve post-operative healing times. Suitable applications for CPM devices can, in certain circumstances, include the post-operative therapeutic treatment of: stiffness in joints and supporting tendons, muscles, and related tissues, including, for example, burn injuries, open reduction and rigid fixation of intra-articular, metaphyseal and diaphyseal fractures, tenolysis and arthrolysis, capsulotomy, flexor and extensor tendon repairs and synovectomies, arthrotomy and drainage of acute septic arthritis; flexor and extensor tendon tenolyses, prosthetic replacement of joints and bones, and selected crush injuries of joints and surrounding tissues without fractures or dislocations.

In contrast, CPM devices may not be suitable for treatment applications involving unstable fractures, or diffuse cellulitis or infections, until infection is controlled, or septic tenosynovitis. Such CPM devices must usually be configured to limit the range of motion so as to minimize the potential for post-operative trauma. Substantial harm can unwittingly result from premature and contraindicated over extension of joints and supporting tendons, muscles, and related tissues, and to ensure the post-operative stability of surgical epoxies, staples, sutures, and the like. The physician and physical therapy personnel will determine the appropriate, allowable range of motion and frequency of stimulation to optimize the healing process.

CPM therapy has received general acceptance as a suitable means of improving the recovery conditions for the patient and for reducing post-operative costs, which is attributable to an increased recovery success rate. Many attempts have been made in the past 15 years to commercially develop and produce suitable CPM devices capable of therapeutically treating the majority of joints and tissues of the human body. Such devices have also found application in the veterinary arts. Some of the prior art devices have been directed to correctly mimicking the correct range and path of motion of various body parts including, for example, the neck, hips, legs, knees, ankles, feet, toes, shoulders, elbows, wrists, and fingers. Some devices have been developed to specialize exclusively in the complex motion of the combined knee and ankle, while other devices have focused exclusively on the complex range and path of motion of the hand and fingers, which occurs over very small distances. Many developers of CPM equipment in recent years have also sought to address the need for portable and light-weight devices that can be worn by a patient during daily activity.

One of many such devices directed to CPM treatment of the hand is disclosed in U.S. Pat. No. 5,697,892, to Torgerson for a continuous passive motion device for the hand and a method of using the same. The Torgerson device is limited to a dorsally mounted hand CPM device operative to move the hand through its range of motion. The complex, multi-lever, flexible linkage, and control mechanism can be adjusted to accommodate a wide range of pre-selected motion, and periodicity profiles.

Some of the prior art CPM devices that are intended for treatment of a hand contemplate imparting motion to one or more of the fingers or digits of the hand. Additionally, some of devices are capable of moving only a selected portion of a finger, or a selected joint. As is known to those with skill in the art, a human hand is made up of 3 types of bones, including carpals, metacarpals and phalanges. The carpals form a part of the wrist and are joined to the forearm bones with various connective tissues. The human hand further includes identifiable joints between the above-described bones, which include the metacarpophalangeal, proximal phalanges, and distal phalanges joints, which are commonly referred to by those with skill in the art as the MCP, PIP, and DIP joints, respectively. Each of the joints and bones of the hand have an optimal and nominal range of angular motion as the hand is opened and the fingers are extended and over-extended, and as the hand is closed and they are curled up into a fist. CPM devices contemplated in the prior art preferably move the fingers into flexion (closed-fist) and into extension (open hand) during recuperative therapy so as to substantially approximate the normal anatomical motion of the joints. In normal use, the anatomically proper range of motion, acknowledge by many having skill in the art, of the MCP joint motion is approximately between 0 degrees (open hand) and 90 degrees (closed fist). The anatomically proper range of combined motion of the MCP, PIP, and DIP joints is substantially between about 0 degrees (open hand) and 260 degrees (closed fist).

Another CPM device for treatment of a hand is disclosed by Kaiser et al. in U.S. Pat. No. 5,683,351. Kaiser et al. teach, among other limitations, a CPM device that incorporates an intricate arrangement of 3 links and 4 gears configured to impart a reciprocating epicycloid path of motion to a prime mover connected to one or more of a patient's fingers, and operative to flex one or more sets of finger joints. Although not specific benefits are not explained in the disclosure, Kaiser et al. purport to improve patient recovery by use of the epicycloid path of motion to impart a perpendicular force to the fingers during treatment, instead of a spiral motion.

U.S. Pat. No. 5,327,882 to Saringer et al. is restricted to a continuous passive motion device that includes a forearm splint mounting a reversibly motorized rotatable gear mechanism that rotates a digit attachment member connected to the patient's fingers, which follows a compound spiral path of motion. U.S. Pat. No. 5,115,806 to Greuloch, et al. also discloses a continuous passive motion device for imparting a reciprocating spiral motion to the digits of the hand including the thumb. In related U.S. Pat. No. 4,962,756 to Greuloch et al.'s co-inventors, Shamir et al., the focus is directed to a spiral inducing CPM machine that mounts dorsally for treatment of the 4 fingers and in a palmer aspect for treatment of the thumb. U.S. Pat. No. 4,679,548, issued Jul. 19, 1987, to Pecheux, also relates to a CPM hand device that imparts a spiral motion with a single, motor-driven slide guide. Weinzweig discloses a removable flexible finger covering with a fingertip connector clip in U.S. Pat. No. 5,261,393, which is purported to be compatible for use with a CPM device that includes linearly actuated finger drive bars.

Continuous passive motion devices and methods are described by Brook, et al. in U.S. Pat. No. 4,875,469, which is limited to a system for continuous passive motion of a limb or one or more fingers. The Brook et al. device includes a motor driven reciprocable carriage coupled to a drive belt. The motor and drive belt further drive a second drive belt that carries sensors to control limits of motion. The carriage is connected to spring-biased, adjustable length finger actuators, which can be actuated to provide predetermined dwell times at limits of flexion and extension. The preferred embodiment includes finger actuator assemblies having spring biased and telescoping hollow base tubes, hollow extension rods, and resilient wire elements, which cooperate to impart motion to the fingers.

U.S. Pat. No. 4,665,900 issued May 19, 1987 to Saringer discloses a device that is fitted to the palmer side of the forearm and mounts a CPM device, which uses elongated wire rod travelers to linearly push and pull fingers. Yates et al. describe a hand exerciser in U.S. Pat. No. 4,644,938, which operates using elastics tending to bias fingers into a flexed position, and an intermittently actuatable cable that counters the elastic force to pull the fingers into an extended position.

In all such attempted treatment solutions and CPM applications, there has long been a need to provide the patient and the treating physician and physical therapist with an easy to use, inexpensive, and convenient means for not only mobilizing various traumatized tissues during recovery, but which are also easy to mass-produce and which include the capability to be easily and optimally fitted to accommodate the unique anatomical arrangement, size, and range and path of motion of the patient's limbs and body parts. While many attempts have been made with respect to hand CPM devices to ensure spiral or epicycloidal paths of motion, the added complexity of such devices may have hindered wider commercial acceptance and large-scale economic availability. Other efforts have been expended to develop less complicated devices, but those attempts have failed to offer the flexibility and capability of their more complex counterparts.

In each of the noted applications and situations, cumbersome and expensive automated CPM machines and devices are generally economically unjustifiable and impractical for use in an outpatient arrangement where minor malfunctions of the complicated and intricate devices may not be easily corrected by the patient.

What has been needed but heretofore unavailable, is an apparatus that not only easily accommodates a wide variety of CPM applications, but which can also be adapted and configured for use, without undue burden to the treating physician or physical therapist, to the inevitable anatomical peculiarities unique to each new patient. Moreover, the preferred CPM apparatus should be easily adapted to perform well with any of the aforementioned applications and in all of the range of motion situations described above and contemplated herein.

The present invention meets these and other needs without adding any complexity, inefficiencies, or significant costs to manufacturing, using, repairing, and refurbishing CPM devices made according to the present invention. The various embodiments of the present invention disclosed herein are readily adapted for ease of manufacture, low fabrication costs, and immediate compatibility with the infinitely variable anatomical arrangement, size, and range and path of motion of patient's limbs and body parts.

### SUMMARY OF INVENTION

In its most general sense the present invention overcomes the shortcomings of the prior art in any of a number of generally and equally effective configurations. In one of the exemplary embodiments, this invention includes a continuous passive motion (CPM) apparatus for therapeutic treatment of at least one finger of a patient's hand. The apparatus incorporates a hand splint adapted to be worn about a forearm of the patient proximate to the hand and preferably in a palmer aspect orientation. A drive unit is carried from the palmer aspect position of the splint and includes a motor driven, reciprocating drive tube that is actuatable over a user-selectable range of motion. The drive tube propels a flexion and extension assembly that includes at least one finger motion assembly, which is pivotally interconnected to a proximal end of the drive tube by a quaternion coupler adapted to enable movement of the finger motion assembly in at least 2 degrees of freedom relative to the coupler. In alternative variations, the finger motion assembly may be interconnected to the coupler for motion in multiple degrees of freedom relative to the hand splint. In yet other modifications to the instant exemplary embodiments, the coupler may be adapted to interconnect one or multiple finger motion assemblies to one or more corresponding fingers of the hand. Also, the at least one finger motion assembly may be adapted to, in operation, mobilize one or more finger(s) during treatment.

Preferably, the quaternion coupler cooperates with the finger motion assembly to enable adjustment thereof in multiple degrees of freedom, and more preferably in at least 3 degrees of freedom, and most preferably in at least 4 degrees of freedom, as is described in more detail below. The coupler derives its name from this latter, most preferred 4 degree of freedom variation. As will be explained below at length, the coupler's name also derives from other features and capabilities. In this exemplary configuration, the coupler is adapted to releasably engage the finger motion assembly after adjustment to accommodate the anatomical arrangement, size, and range and path of motion of the at least one finger.

The finger motion assembly also further preferably includes at least one finger splint that is releasably connected to a distal end of the assembly. The finger splint is adapted to receive a distal phalanx of the at least one finger and is formed from a flexible sheet material that incorporates layers selected from the group including stiffening, bend memory, and hypo-allergenic adhesive layers.

The drive unit of an exemplary configuration of the continuous passive motion apparatus according to the present invention preferably includes control electronics that include a ladder logic switching circuit having at least one relay and a plurality of limit and contact switches in electronic communication with the control electronics and the motor and operative to reversibly actuate the motor to move the drive tube over the selectable range of motion. More preferably, the control electronics draw power from the power source only during a period of time during which the direction of operation of the motor is reversed by the control electronics.

The present invention also contemplates an exemplary embodiment of a finger motion assembly for use with a CPM apparatus and for therapeutic treatment of at least one finger of a patient's hand. The finger motion assembly incorporates a resilient prime mover formed from a rod material selected to be repeatedly bendable without damage and to have a bend memory and material property that withstands repetitive tensile, compressive, and shear loads. Preferably, the prime mover is further formed to have, as measured between proximal and distal ends, an acute angle of approximately between 0 and 90 degrees anywhere along its longitudinal length. Further, an adjustable and releasable finger attachment clip is mounted from the distal end of the rod, which is adapted to receive the at least one finger. The prime mover also has an adjustable attach device formed about the proximal end, which is configured for adjustment in at least 2 degrees of freedom, and which is adapted to connect to and be actuated by the continuous passive motion apparatus.

The rod material of the finger motion assembly of this embodiment is preferably selected from the group that includes powdered, machined, drawn, stamped, rolled, extruded, and forged thermoplastics, and super-elastic, shape memory metals, alloys, and combinations, mixtures, compositions, and hybrids thereof. More preferably, the thermoplastic material is selected from the group including acetal resins, delrin, fluorocarbons, polyesters, polyester elastomers, metallocenes, polyamides, nylon, polyvinyl chloride, polybutadienes, silicone resins, ABS (acrylonitrile, butadiene, styrene), polypropylene, liquid crystal polymers, combinations and mixtures and composites thereof, and reinforced combinations and mixtures and composites thereof. In alternative variations of this embodiment, the rod material is a super-elastic, shape memory metal alloy selected from the group including Nitinol, Hastelloy, Elgiloy, W35N, Haynes, Inconel, Nimoin, Nispan C, Monel, Waspaloy, Incoloy, 300 series and 400 series stainless steel, and titanium, and alloys, combinations, mixtures, compositions, and hybrids thereof. In yet other modifications, the rod material may be formed from a hybrid material, structure, or composition that includes any of the preceding metals and thermoplastics.

The instant embodiment also contemplates that the adjustable attach device is formed on the rod includes a threaded end on the proximal end that is adapted to be threadably and pivotally interconnected to the continuous passive motion apparatus by a coupler adapted to enable movement of the finger motion assembly in multiple degrees of freedom relative to the coupler. Preferably, the coupler is further adapted to releasably engage the finger motion assembly after adjustment to accommodate the anatomical arrangement, size, and range and path of motion of the at least one finger during operation of the continuous passive motion apparatus. In alternatives of any of the preceding embodiments, the adjustable attach device is formed from a releasable connection device such as a bayonet end adapted to be telescopically and pivotally interconnected to the continuous passive motion apparatus by a coupler adapted to enable movement of the finger motion assembly in multiple degrees of freedom relative to the coupler.

The preceding exemplary embodiments of the coupler may be further adapted to releasably engage the finger motion assembly after pivotal positional adjustment and bending of the prime mover, if necessary, to accommodate the anatomical arrangement, size, and range and path of motion of the at least one finger during operation of the continuous passive motion apparatus.

The finger motion assembly according the preceding illustrative configurations may also further include at least one finger splint releasably connected to the finger attachment clip of the finger motion assembly. The finger splint may be adapted to receive the distal phalanx of the at least one finger. The at least one finger splint is preferably formed from a flexible sheet material that incorporates at least one layer selected from the group including stiffening, bend memory, and hypo-allergenic adhesive layers.

The flexible sheet material may be formed with a planformal profile that incorporates a plurality of wrap tabs configured to substantially encircle at least the distal phalanx of the at least one finger. A plurality of attachment tabs may also be included, which are arranged to be aligned when the wrap tabs are arranged so as to substantially encircle the at least one finger, and to pivotally connect the finger splint to the finger attachment clip.

The present invention is also directed to a flexion and extension actuator assembly for use with a continuous passive motion apparatus that is adapted for therapeutic treatment of at least one finger of a patient's hand. The exemplary flexion and extension actuator assembly includes a coupler that is adapted to be driven and actuated by the CPM apparatus, such as, for example, the previously described drive tube. Received within the coupler is at least one pivot ball that is configured to move about multiple axes of motion. A finger motion assembly is also incorporated that includes an adjustably bendable rod with a proximal end that has an adjustable attach device configured to move about multiple at axes of motion relative to the coupler. Preferably, the pivot ball is adapted to be releasably constrained within the coupler so that the finger motion assembly can be adjusted to optimally conform to the respective anatomical size, arrangement, and range and path of motion of the patient's at least one finger and hand.

The instant exemplary realization of the flexion and extension actuator assembly according to the present invention includes an attach device that incorporates a threaded end adapted to be threadably and pivotally interconnected preferably to the coupler. More preferably the threaded end may be connected to the pivot ball. In both configurations, the movable arrangement enables optimal adjustment of the finger motion assembly in multiple degrees of freedom relative to the coupler and the hand splint. As in previous manifestations of the instant invention, the coupler of this modification may be further adapted to releasably engage the finger motion assembly after adjustment to accommodate the unique anatomical arrangement, size, and range and path of motion of the at least one finger during operation of the continuous passive motion apparatus. Also, at least one finger splint formed from a flexible sheet may be incorporated as described in connection with other embodiments, modifications, and variations.

A new and novel finger splint is also contemplated by the present invention that is compatible for use with a variety of CPM devices and which is adapted to receive a distal end of at least one finger of a patient's hand. The finger splint incorporates, among other elements, a substantially planar flexible sheet material that formed with a resilient stiffening layer, a bend memory layer, a hypo-allergenic adhesive layer, and a releasable adhesive protective liner. The splint also preferably includes a plurality of wrap and attachment tabs that are formed in the sheet and configured to, in operation, substantially encircle at least the distal phalanx of the at least one finger. Each of the plurality of attachment tabs is formed with a recess, which are aligned when the finger is received within the splint. The splint is preferably pivotally connected to the continuous passive motion apparatus about the aligned recesses.

In desirable variations to the instant finger splint configuration, the resilient stiffening layer is preferably a thermoplastic sheet material. More preferably, the material is selected from the group including plastic and paper films and sheets, polyethylene, polyethylene naphthalate, metallocenes, polypropylene, cellulosic acetal resins, fluorocarbons, polyesters, polyester elastomers, polyamides, vinyl, polyvinyl, nylon, polyvinyl chloride, polybutadienes, silicone resins, ABS, liquid crystal polymers, combinations and mixtures and composites thereof, layups thereof, and reinforced combinations and mixtures and composites thereof.

In other modifications to the present finger splint arrangement according to the present invention, the bend memory layer is preferably a metallic sheet material of at least one layer. More preferably, the metallic sheet material is selected from the group including metallic foil, metallic film, aluminum foil, stainless steel foil, and alloys, layups, combinations, compositions, and hybrids thereof. Most preferably, the bend memory layer is preferably a thin metallic sheet material of multiple layers. In yet additional alternative variations, the hypo-allergenic adhesive layer of the finger splint is selected to be a biologically compatible and releasable adhesive selected from the group including an of a variety of water-based releasable adhesives including, for example, water based rubber resins and water based non-rubber resins.

The releasable adhesive protective liner of the finger splint is preferably a silicone coated paper or kraft paper that is affixed to the adhesive for protection until use. More preferably, the protective liner is selected from the group including coated papers and plastics (including, for example, the aforementioned thermoplastics), kraft paper, polycoated paper and plastic liners, and silicone coated paper and plastic liners.

The present invention also contemplates a finger immobilization splint that is adapted for use with the CPM apparatus disclosed above. The exemplary embodiment of the finger immobilization splint is adapted to immobilize at least one joint of a finger of a patient's hand and includes a construction that is similar to that of the aforementioned finger splint. The immobilization splint, however, does not generally, although it may, incorporate attachment tabs, but it may include additional wrap tabs. Preferably, the immobilization splint is made from a substantially planar flexible sheet material, which incorporates a resilient stiffening layer, a bend memory layer, a hypo-allergenic adhesive layer, and a releasable adhesive protective liner. Also included are a plurality of wrap tabs that are formed in the sheet and configured to substantially encircle at least one joint of the at least one finger. When installed, the at least one joint is thereby immobilized as each of the plurality of wrap tabs substantially encircles the at least one finger and thereby prevents the finger from being flexed. The finger immobilization splint may be constructed in the same fashion and using the same types of materials already described in connection with the finger splint.

These exemplary embodiments, and the variations, alternatives, modifications, and alterations thereof may be used either alone or in combination with one another as will become more readily apparent to those with skill in the art with reference to the following detailed description of the preferred embodiments and the accompanying figures and drawings.

### BRIEF DESCRIPTION OF THE DRAWINGS

Without limiting the scope of the present invention as claimed below and referring now to the drawings and figures, wherein like reference numerals across the several drawings, figures, and views refer to identical, corresponding, or equivalent elements, features, and parts:

FIG. 1 is a perspective view, in reduced scale, of a continuous passive motion (hereafter referred to as “CPM”) apparatus for therapeutic mobilization and treatment of a hand, shown nearly in full extension, according to the present invention;

FIG. 1A is a detail, in enlarged scale, of the threads of a jack screw of the CPM apparatus of FIG. 1 taken within detail view line 1A;

FIG. 1B is a detail, in enlarged scale, of the threads of an actuation device formed on a rod of the finger motion assembly of the CPM device of FIG. 1 taken within detail view line 1B;

FIG. 2 is a rotated, planform view, in enlarged scale, of the drive unit of the CPM apparatus of FIG. 1; and

FIG. 3 is a planform view of the drive unit of the CPM apparatus of FIG. 2 with certain structure removed for clarity.

FIG. 4 is a rotated view of the CPM apparatus of FIG. 1 showing the CPM apparatus retracted and the hand substantially in fill flexion;

FIG. 5A is a circuit diagram of an electrical circuit suitable for use with the CPM apparatus of FIG. 1;

FIG. 5B is a circuit diagram of an electrical circuit suitable for use with the CPM apparatus of FIG. 1;

FIG. 6 is a rotated, enlarged section view of the CPM apparatus of FIG. 4, with certain structure removed for clarity, taken along section line 6-6;

FIG. 7 is a rotated, section view of the CPM apparatus of FIG. 4, with certain structure removed for clarity, taken along section line 7-7;

FIG. 8 is a rotated, section view of the CPM apparatus of FIG. 6, with certain structure removed for clarity, taken along section line 8-8;

FIG. 9 is a view of the CPM apparatus of FIG. 1, with some structure removed for clarity, in combination with an additional CPM apparatus positioned to treat a thumb;

FIG. 10 is a rotated, reduced scale, side view of the CPM apparatus of FIG. 4, with certain structure and anatomy removed for clarity;

FIG. 11 is a rotated, reduced scale, side view of the CPM apparatus of FIG. 4, with certain structure and anatomy removed for clarity, and depicting a modification to a finger motion assembly;

FIG. 12 is a view of the CPM apparatus of FIG. 11, with certain structure and anatomy removed for clarity, and illustrating an alternative configuration to a finger splint arrangement;

FIG. 13 is a rotated planform view, in enlarged scale, of an exemplary embodiment of the finger splint of FIGS. 11 and 12, with certain structure and anatomy removed for clarity, and illustrating the finger splint in an uninstalled configuration;

FIG. 14 is a rotated, section view, in enlarged scale, of the finger splint of FIG. 11, taken along section line 14-14;

FIG. 15 is a perspective view, in reduced scale, of the finger splint of FIG. 13, partially receiving a distal end of a finger;

FIG. 16 is a top view of the finger splint of FIG. 13 fully received on the finger and showing the method of attachment to the CPM apparatus; and

FIG. 17 is a perspective view, in reduced scale, of a finger immobilization splint partially received on a finger.

### DESCRIPTION OF THE EXEMPLARY EMBODIMENTS

The continuous passive motion (hereafter referred to as “CPM”) apparatus of the present invention is a significant advance in the state of the art of such devices. The present invention with all of its contemplated embodiments and variations, decreases the costs normally associated with such technology while maintaining all the needed capabilities and benefits. The CPM apparatus according to the present invention is not only easier to produce, but it is also far easier to maintain and refurbish for repeated uses over its lifetime. Even more notably, the instant invention is far more flexible and compatible for adaptation and configuration for use with the interminable and unique anatomical variations that exist with patients. The preferred embodiments and various modifications of the preferred CPM apparatus accomplish these benefits by new and novel elements and arrangements that are configured in unique and novel ways and which demonstrate previously unavailable capabilities.

The CPM apparatus of the instant invention is ideally suited for use in recuperative therapy applications to the human hand. The exemplary CPM apparatus is configured to mobilize the tissues and joints of the fingers in an anatomically beneficial motion that does not produce joint irritation, expansion, or compression. Despite claims in earlier devices that the proper motion must be precisely along a spiral or epicycloidal path, experience has shown that the human fingers, and the correspondingly “proper” anatomical range and path of motion, like that of many other body parts, varies greatly from person to person. In light of this fact, it has been that what has been needed more than a device that approximates spiral or epicycloidal path of motion, is a device that can be optimally configured for and adjusted for the best possible compatibility with the unique anatomy of the each specific patient that needs recuperative therapy. The CPM apparatus described here is configurable to produce exclusive MCP joint motion, or composite motion of all finger joints, including the MCP, DIP, and PIP joints.

A preferred lexicography is used in the following description in connection with the accompanying figures only for purposes of illustration and is intended to limit the scope and breadth of the invention, which is only limited by the accompanying claims. By way example, the words “upper,” “lower,” “outwardly,” “inwardly,” “below,” “above,” “left,” and “right” are merely intended to describe relative directions in the drawings to which the reference is made. Derivatives, combinations, and words of similar meaning and context of such words will be used with analogous intent.

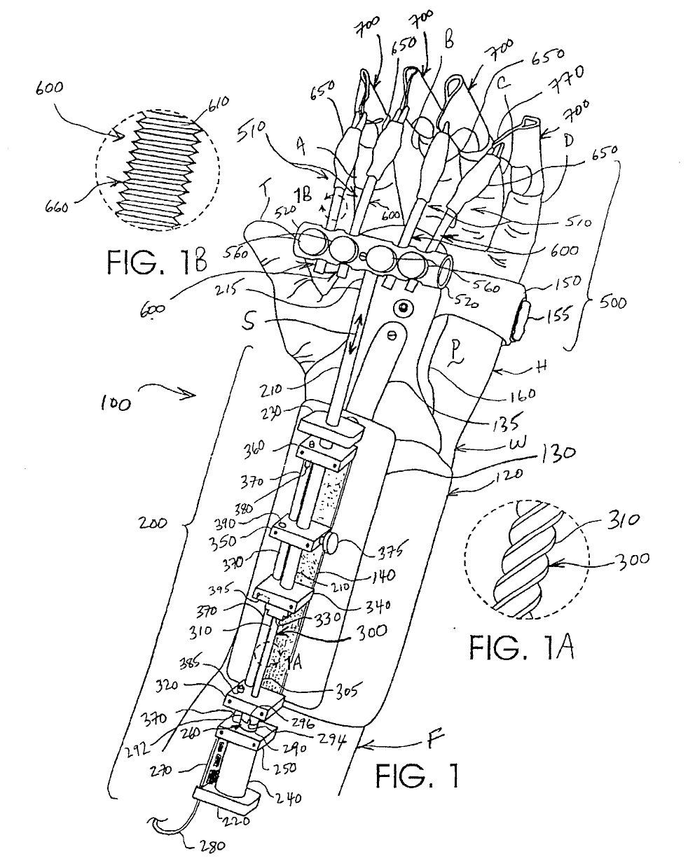

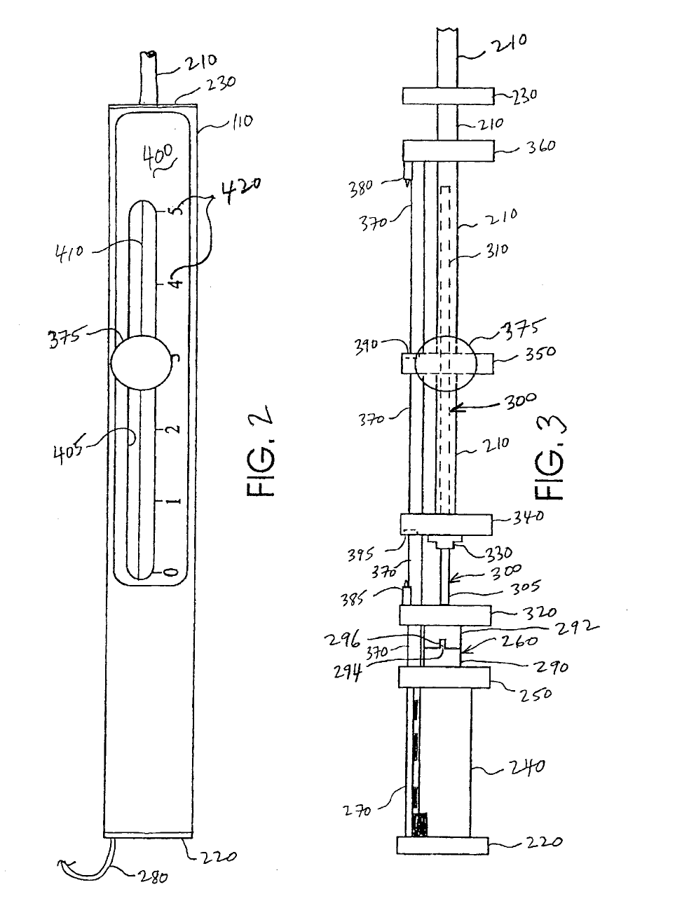

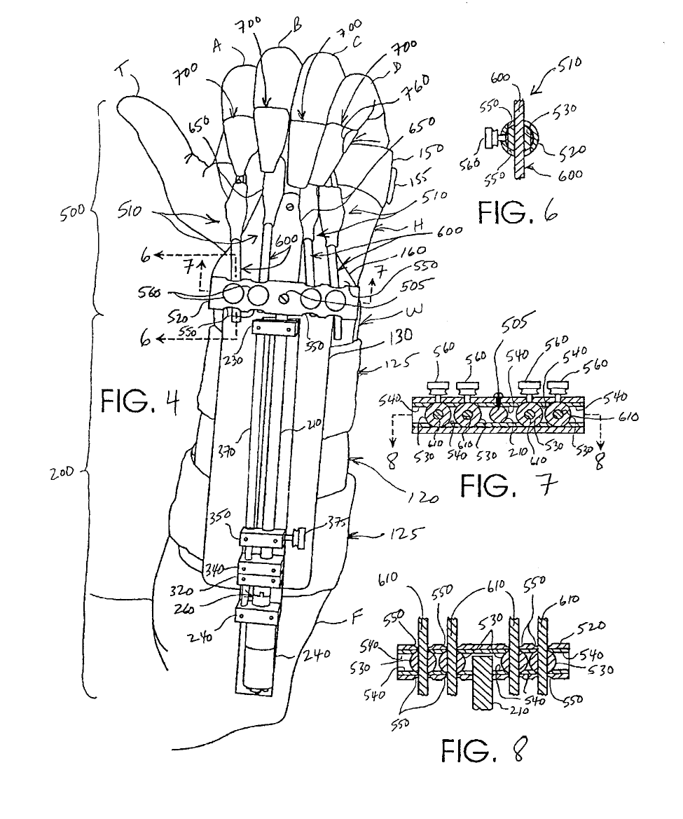

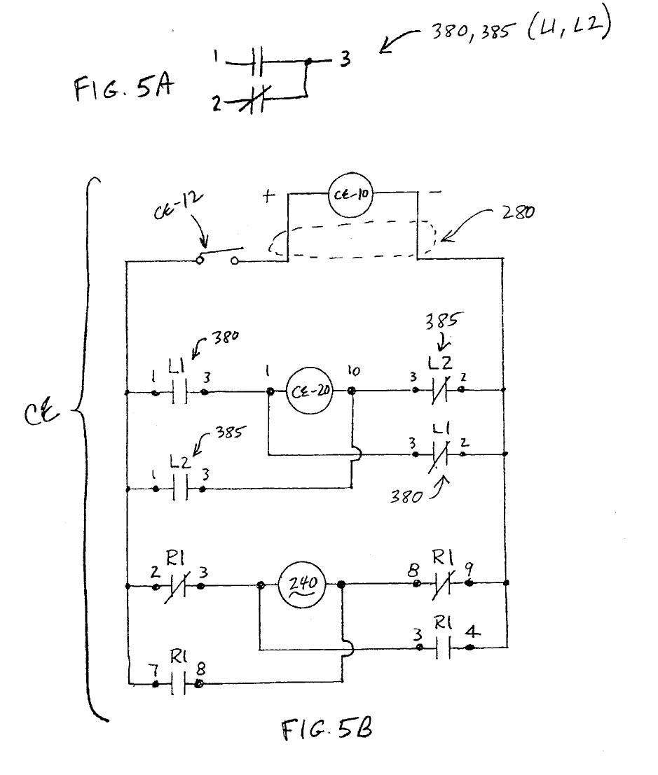

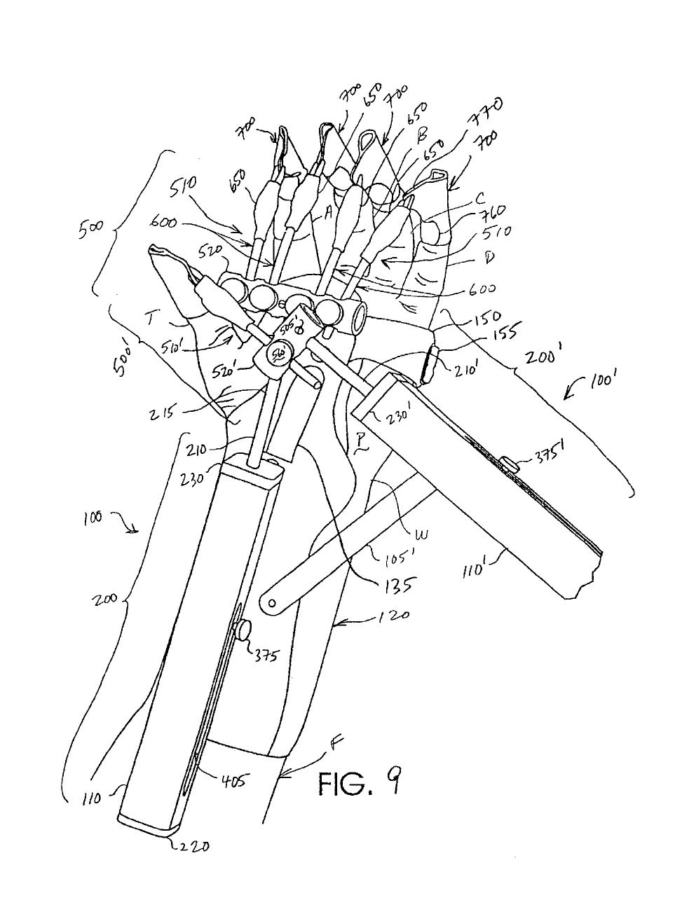

With reference now to the various figures, and specifically to FIG. 1, an exemplary configuration of the present invention includes a continuous passive motion (CPM) apparatus 100 for therapeutic treatment of at least one finger A, B, C, D of a patient's hand H. As represented in FIG. 1 and subsequent figures, the apparatus 100 is not necessarily shown to scale but is shown in one of many possible and equally desirable representative dimensional proportions, as will be apparent to those with skill in the art. The exemplary illustration shown in FIG. 1 depicts the apparatus 100 without a cover 110, which is shown in other later figures, but which is removed for purposes of illustration (but see, for example, FIG. 2). The apparatus 100 incorporates a hand splint 120 adapted to be worn about a forearm F of the patient proximate to the hand H and preferably in a palmer aspect orientation. The hand splint 120 can be any of a wide variety of readily available commercial devices, which may include, for example, adjustable forearm straps 125 (shown in FIG. 4). The hand splint 120 is configured with a palmer aspect mounting surface 130 that can be adapted to mount other components of the apparatus 100 as will be described in more detail below. Mounting surface 130 may be further supported and attached to hand splint 120 with a reinforcement member 135. In the preferred configuration, the mounting surface 130 includes a fastener or fastening device that is adapted for easy mounting and removal of components of the apparatus 100, such as, for example without limitation, snaps, a bayonet type key and keyway assembly, and a strip of loop and hook-type fastener material 140, such as Velcro® available from DuPont.

Although not essential for purposes of the instant invention, one variation of hand splint 120 that is suitable for purposes of the instant configuration may further incorporate a palm support 150 operative to immobilize the wrist W of the patient when used in cooperation with an adjustable splint strap, such as strap 155, which is configured to cooperate with a stiffened palm seat 160 that conformally extends into the palm P of the hand H. Also, the palm support 150 may be further pivotally mounted to the hand splint 120 with a pivot pin 170, which may be, for example, a rivet or nut and bolt combination. In this variation, the hand splint 120 may be adjusted for recuperative therapeutic treatments that require adductive and/or abductive positioning of the hand H relative to the forearm F and about the wrist W during CPM application.

Although not shown in the figures, the present invention also contemplates incorporating a variable wrist immobilization device that can immobilize the wrist W in an infinite number of positions, which may be prescribed by a treating physician or physical therapist. Alternatively, depending upon the needs of the patient, the hand splint 120 may also be designed to allow free movement of the wrist for recuperative therapies that prefer controlled, CPM of the wrist in toll addition to the fingers and hand. Additionally, the hand splint 120 can be further modified to immobilize on or more fingers or joints thereof so that the CPM apparatus only moves the fingers to be treated. Further, the hand splint 120 can be used in conjunction with individual finger immobilizer splints as described in more detail below.

The apparatus 100 also includes a drive unit 200 that includes a lower surface (not shown) that incorporates a hook and loop fastener strip (not shown) that corresponds with fastener strip 140. Preferably, the drive unit 200 is mounted thereby on the palmer aspect position of the splint 120. The unit 200 includes a reciprocating drive tube 210 that is actuatable over a user-selectable range of motion. Although many various and equally suitable drive mechanisms can be employed for purposes of the exemplary embodiment, the drive unit shown in the figures, and specifically in FIG. 1, includes a cover 110 (removed in FIG. 1 for clarity, but shown in other figures including FIGS. 2 & 3) and a lower proximal end cap 220 opposite a distal end cap 230, which together with cover 110 comprise the exterior of the drive unit 200. The cover 110 may preferably be formed from any suitable metal or thermoplastic, including for example without limitation, high-strength, impact-resistant ABS plastic. The end caps 220, 230 may be similarly formed from metal or thermoplastic, and may preferably formed from an easily formed and machined thermoplastic such as Delrin® from DuPont.

The drive unit 200 preferably includes an actuation assembly that is driven by a motor 240, which is mounted to motor mount 250. Although many types of motors are suitable for purposes of the present invention, a preferred, variable speed, reversible motor 240 includes, for example but not for purposes of limitation, Model No. D33D57M25H0366, which is available from Stock Drive Products, of New Hyde Park, New York, USA. The drive shaft of motor 240 is sized and configured to rotatably protrude above the motor mount 250 to drive coupler 260, which drives jack screw 300. For an improved rate of translational motion of the CPM apparatus, per revolution of the motor drive shaft, the jack screw 300 is more preferably selected to have or to be formed with multiple threads having an extremely course pitch, as can more easily be understood with specific reference to FIG. 1A. One type of suitable jack screw 300 is available, for example, as Model No. 6642K4, from McMaster-Carr Supply Company of Cleveland, Ohio, USA.

Although not shown in detail in the figures, the motor 240 is preferably battery powered or otherwise electrically powered so as to facilitate portability of the CPM apparatus 100. As can be appreciated by those with skill in the art, a battery supply is easily interchangeable with a variety of commercially available alternating and direct current adapters that can be configured for use with the present invention, and which would be suitable for applications that do not require portability. Additionally, the motor is preferably controlled by an electronic control circuit contained on circuit board 270, which is in electrical communication with the power supply, such as the battery, through power cord 280, and various other sensors, such as limit and contact switches, that will be further described below.

Although not essentially required for satisfactory operation, for purposes of allowing for tolerance stack up and misalignment of the various actuation assembly components, and to allow for preassembly of certain components, a coupler such as coupler 260 should preferably be able to accommodate coupling of the motor drive shaft and the jack screw 300, and may preferably include a motor-drive-shaft-mounted lower portion 290 and an upper portion 292 joined to lower proximal end 305 of the jack screw 300. The upper and lower portions 290, 292 may be joined together using any suitable means, such as, for example, a key 294 formed on the lower portion 290 and a keyway 296 formed in the upper portion 292 to receive the key 294. The motor mount 250, coupler 260, and similar components may be formed from any suitable material including, for example but not limitation, metals and thermoplastics. One thermoplastic that has been found to be light-weight, high-strength, and conveniently formable and machinable includes Delrin® from DuPont.

The jack screw 300 is formed from a high-strength, high-durability steel alloy or thermoplastic, and to have a large pitch acme thread 310, as can be understood with additional reference to FIG. 1A. The jack screw 300 is preferably rotatably received about its proximal end 305 through a recess formed in shaft support 320. The upper portion 294 of the coupler 260, which is joined to the lower proximal end 305 of the jack screw 300 rotatably captivates the jack screw 300 to the motor mount 250. In operation, the jack screw 300 is engaged about its upper distal end 310 with an acme thread compatible nut plate 330 that is joined to, recessed within, and/or integrally formed within the drive yoke 340. In this arrangement, as the motor 240 drives the jack screw 300, the nut plate 330 and the drive yoke 340 are actuated. The nut plate 330, although shown in some of the figures to protrude downwardly from the drive yoke 340, may also be mounted in a recessed position thereon, as can be understood with reference to FIG. 4, where the drive yoke 340 is shown adjacent to the shaft support 320.

The aforementioned drive tube 210 may be formed from a high-strength hollow metal or thermoplastic tube and is joined about its lower proximal end 212 to the drive yoke 340. As reflected in the various figures, and specifically with reference now to FIGS. 1-4, it can be understood that the drive tube 210 is further slidably received through respective recesses formed in range of motion (hereafter referred to as “ROM”) adjuster 350, distal support 360 and distal end cap 230. Drive tube 210 is configured for slidable movement in the direction of the double-headed arrow labeled S. Shaft support 320 is fixed in position relative to the motor mount 250, and the distal support 360 by support guide rod 370, which is fixedly received through and captured by each of the elements, 250, 320 and 360.

As noted above, drive tube 210 is received through a recess formed in and releasably engaged by ROM adjuster 350, which operates to selectably adjust the range of motion desired by the treating physician or physical therapist, as described in more detail below. ROM adjuster 350 releasably engages drive tube 210 by actuation of engagement mechanism 375, which is shown for purposes of illustration, but not limitation, as being a thumb-type screw 375 that is threadably received in a recess formed in ROM adjuster 350, which, when tightened, engages drive tube 210, whereby ROM adjuster 350 moves along with drive tube 210 during actuation.

In operation, jack screw 300 impels drive yoke 340, drive tube 210, and ROM adjuster 350 in the linearly reciprocating directions described by the arrow labeled S. Upper and lower limit switches 380 and 385, are respectively mounted to distal support 360 and shaft support 320 and are in electronic communication with control electronics CE contained on circuit board 270.

Although many types of limit switches are contemplated as being suitable for purposes of the instant configuration, in the exemplary embodiment shown in the figures, the limit switches 380, 385 are magnetically actuated by correspondingly mounted magnets 390 and 395 (not shown in all figures but represented as hidden lines in FIG. 3). Preferably, magnet 390 is mounted on ROM adjuster 350 and magnet 395 is mounted on drive yoke 340. One type of compatible limit switch 380, 385 includes, for example, the reed switch having Model No. HSR520RT from Hermetic Switch, Inc., which is available as Part No. 808-0005 from Allied Electronics, Inc., of Worthington, Ohio, USA.

Preferably, limit switches 380 and 385 are magnetically actuated, double-pole, reed switches having what is commonly referred to by those with skill in the art as a “Form C” circuit construction (known for its circuit diagram representation resembling the letter “C”), which can be understood with reference to FIG. 5A, wherein symbology standard to a wide variety of electronics conventions is depicted. As shown in the FIG. 5A, the preferred switch 380, 385 includes one pole, between terminals 1 and 3, as a normally open switch, and the other pole as a normally closed switch. With reference next to FIG. 5B, an exemplary electrical circuit useful for purposes of the instant invention includes control electronics CE, mounted in part to circuit board 270, which are greatly simplified and far more energy efficient compared to other more cumbersome prior art devices. The apparatus 100 constructed according to the present invention has demonstrated battery powered operation, for purposes of illustration but not limitation, of approximately between 40 and 72 hours and more, which is more than an order of magnitude improvement over comparable prior art devices.

The exemplary apparatus 100 can therefore be used for much greater periods of time with conventional battery power supplies using, for example but not limitation, commercially available size “AA” 1.5 volt batteries (not shown in the figures) in a series of 4 batteries to generate a total of 6 volts. The control electronics CE includes, among other elements, a switched power supply CE-10 (with a switch CE-12) as already mentioned, and what is commonly referred to by those with skill in the art as a “ladder logic” switching circuit (known for its circuit diagram representation that resembles a ladder) that includes, for example, a single latch coil relay CE-20 having at least 2 “Form C” type, integrally contained, multi-pole, contact-type switches, which are labeled in FIG. 5B generally as R1.

As diagrammatically reflected in the circuit drawing of FIG. 5B, the first pole of the CE-20 R1 relay is a normally closed switch between terminals 2 and 3, the second is a normally open switch between terminals 3 and 4, the third is a normally open switch between terminals 7 and 8, and the last is a normally closed switch between terminals 8 and 9. As shown in FIG. 5B, the only continuous energy drain on the power supply CE-10 is the motor 240. The remainder of the circuit does not consume any power except during the transition state when the magnets 390, 395 move proximate to the corresponding limit switches 380, 385 thereby energizing the latch coil of the relay CE-20 and changing the state of the limit switches 380, 385 and of the contact switches R1 of the relay CE-20. This extremely desirable result significantly increases the battery fife of the apparatus 100 when compared with the prior art devices.

As briefly noted above, magnet 390 is mounted on ROM adjuster 350 so that as adjuster 350 moves upwardly with drive tube 210 to a point proximate to limit switch 380, limit switch 380 sends a signal via one or more wires connected to circuit board 270, which the control electronics CE respond to by energizing the latch coil of relay CE-20. In turn, the control electronics CE thereupon change the state of the limit switches 390, 395 and contact switches R1 to reverse the direction of motor 240 so that drive tube 210 begins to move in the opposite direction. This motion continues until, as best reflected in FIG. 4, magnet 395 reaches a position proximate to limit switch 385. At this point limit switch 385 communicates a signal to the control electronics, causing the motor 240 to reverse direction again, moving the drive tube again upward, and so on for the duration of the CPM treatment.

Although not depicted in the various figures, those with ordinary skill in the art will appreciate that addition of an adjustable timer and delay circuit may be accomplished to program selectable delays into the operation of the apparatus 100, whereby the drive unit 200 can be adapted to intermittently and periodically pause at preselected intervals and positions. For example, the drive unit 200 can be adapted to pause after full extension or after full flexion, or both. Alternatively, it can be configured to pause at selectable intervals along the path of motion between the limits of the selectable range of motion.

With continued reference to FIGS. 1-4 and specifically to FIG. 2, the user, treating physician, or physical therapist selects the desired range of motion using scale 400 as a guide. The scale 400 may be calibrated for actual distance measurement or a unit scale devised and calibrated with various indicia, such as numerals 420, to correspond with various treatment regimes. The cover 110 preferably includes a slot 405 that includes a wiper-blade-type cover 410 that protects the interior of apparatus 100 from debris and contamination while enabling engagement mechanism 375 to slide through a slit integrally formed in cover 410.

In operation, the drive tube 210 reciprocates a flexion and extension assembly 500 that includes at least one finger motion assembly 510, which is pivotally interconnected to a proximal end 215 of the drive tube 210 by a quaternion coupler 520 adapted to enable movement of the finger motion assembly 510 in multiple degrees of freedom or in at least 2 degrees of freedom relative to the hand splint 120 or the coupler 520, or both. The coupler 520 may be selected to be tubular in shape as reflected in the figures. However, one with skill in the art can appreciate with reference to the general concept illustrated in the figures that other cross-sections are also well-suited to the instant modifications, including, for example, ovoid, square, and rectangular cross-sections. The drive tube 210 may be connected to the coupler 520 by any of a variety of suitable methods, including, for example without limitation, a set screw 505 that is received in the coupler 520 to engage the drive tube 210 therein.

With continued reference to FIGS. 1-4 and additional reference to FIGS. 6-9, one with skill in the art will recognize one of many equivalent configurations available for establishing multi-axis freedom of motion. Preferably, an exemplary embodiment of the present invention will include, for purposes of illustration but not limitation, the at least one finger motion assembly 510 that is interconnected to a coupler 520, which is adapted to interconnect one or multiple finger motion assemblies 510 to one or more corresponding fingers A, B, C, D, T of the hand. Also, the at least one finger motion assembly 510 may be preferably adapted to, in operation, mobilize one or more finger(s) A, B, C, D, T during treatment.

In the exemplary arrangement illustrated in the various figures, the quaternion coupler 520 cooperates with the at least one finger motion assembly 510 to enable adjustment thereof in multiple degrees of freedom by a novel configuration that includes a pivot ball 530 received within the coupler 520, which corresponds with each finger motion assembly 510. Use of a rotating pivot ball 530, or equivalently configured device, establishes at least 3 degrees of rotational freedom. Additional degrees of translational freedom may be incorporated by various interconnection methods that can be used to connect the finger motion assembly 510 to the coupler 520 and the pivot ball 530.

Preferably, one pivot ball 530 or equivalent device is rotatably received within the coupler 520 for each finger motion assembly 510 that is employed. In configurations that include multiple assemblies 510 and pivot balls 530, tubular or equivalently configured ball spacers 540 may be received within the coupler 520 to maintain spacing between the balls 530. In alternative variations, (not shown but which can be understood with reference to the various figures by those having skill in the art) the coupler 520 may be sized in length so that the pivot balls 530 are retained therein only by end spacers, such as spacers 540 as shown most readily in FIG. 7 received in the ends of coupler 520, whereby the pivot balls 530 maintain proper spacing by contacting one another once received within the coupler 520. The coupler 520 and the pivot balls 530 may be formed from any materials that are compatible for the intended uses, including for example but not limitation, metals and thermoplastics. Preferably, the selected materials will be durable and compatible for extended periods of use and for repair, and refurbishment between uses. Various formulations of high-strength nylon have been found to be suitable for construction of the various elements of the flexion and extension assembly 500.

As contemplated in the preferred arrangements and variations reflected in the figures, between one (see, for example, FIG. 9) and up to four pivot balls 530 may be received within coupler 520 for interconnection of the finger motion assemblies 510 to the drive tube 210. In preferred embodiments, the pivot balls 530 may also be retained within coupler 520 by sizing the pivot balls 530 to have a diameter that is slightly larger than the internal diameter of the coupler 520. In this variation, the pivot balls 530 are preferably formed from a moderately compressible material, such as a thermoplastic, for example nylon, position of each friction fit pivot ball is determined by forming recesses, such as recesses 550, in coupler 520, whereby pivot balls 530 are pressed into position until reaching the top and bottom recesses 550, whereupon the pivot balls 530 are retained by the recesses 550.

In these exemplary configurations and variations, the coupler 520 is further adapted to releasably engage the finger motion assembly 510 after adjustment to accommodate the anatomical arrangement, size, and range and path of motion of the at least one finger A, B, C, D, T. While this can be accomplished with any of variety of methods, an adjustable thumb screw 560 may be threadably received in the coupler 520 and adapted for releasably and frictionally retaining the pivot balls 530 in place after adjustment.

In variations of the preceding embodiments, configurations, and modifications, and with reference to FIG. 9, it can be understood that the present invention also contemplates an additional CPM apparatus 100′ that can be configured as previously described with a drive unit 200′, and a flexion and extension assembly 500′ that includes at least one finger motion assembly 510′. In this alternative configuration, the apparatus 100′ may connected to the hand splint 120 and positioned to apply CPM treatment to a thumb T of the patient's hand H. One possible configuration can include an attachment bar 105′ that can be attached to both the drive unit 100′ and the hand splint 120 as shown. With continued reference to FIG. 9, those having ordinary skill in the art will understand that like reference numerals with primes shown therein correspond with like reference numerals depicted in the other figures.

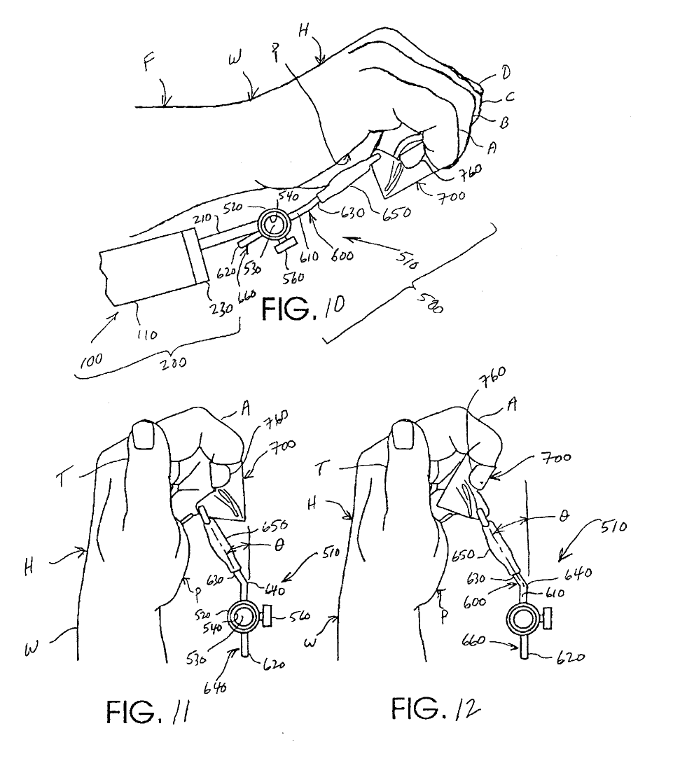

With reference next to FIGS. 10-12 and continued reference to FIGS. 1-9, the present invention also contemplates an exemplary embodiment of the finger motion assembly 510 that incorporates a resilient prime mover 600 formed from a rod material 610 selected to be repeatedly bendable without damage and to have a bend memory and material property that withstands repetitive tensile, compressive, and shear loads. Preferably, the prime mover 600 is further formed to have, as measured between proximal and distal ends, 620, 630, a bend 640 that forms an acute angle θ (FIGS. 11-12) of approximately between θ and 90 degrees anywhere along its longitudinal length. The new capability for bending established unprecedented opportunity for compatibility with a much broader spectrum of patient anatomies. What has been missing from the prior art is a suitable means for accommodating the idiosyncratic anatomy unique to each new patient for whom CPM recuperative therapy is indicated. The improved finger motion assembly 510 according to the present invention with its capability for customization to each patient, and refurbishable reconfigurability for use with a new patient thereafter, overcomes past shortcomings.

In addition, the finger motion assembly 510 incorporates an adjustable and releasable finger attachment clip 650 is mounted from the distal end 630 of the rod 610, which is adapted to receive the at least one finger, such as, for example, finger A. The prime mover 600 also has an adjustable attach 660 device formed about the proximal end 620, which is configured for adjustment in at least 2 degrees of freedom, and which is adapted to connect to and be actuated by the continuous passive motion apparatus 100.

This is preferably implemented by forming threads (see, for example, FIG. 1B) on the rod 610 to be threadably received in the pivot ball 530. In this way, at least 2 degrees of freedom can be established: one degree of translation freedom results from the linear motion induced by the adjustability of the threads, and the second rotational degree of freedom is established by the actual turning of rod 610 as the threads are engaged and the prime mover 600 is adjusted.

The rod material 610 of the finger motion assembly of this modified configuration is preferably selected from a variety of metals and plastics that can be formed by a number of processes including powdered, machined, drawn, stamped, rolled, extruded, and forged thermoplastics, and super-elastic, shape memory metals, alloys, and combinations, mixtures, compositions, and hybrids thereof. More preferably, the thermoplastic material of the rod 610 is selected from any of a variety of commercially available and suitable materials including acetal resins, delrin, fluorocarbons, polyesters, polyester elastomers, metallocenes, polyamides, nylon, polyvinyl chloride, polybutadienes, silicone resins, ABS (acrylonitrile, butadiene, styrene), polypropylene, liquid crystal polymers, combinations and mixtures and composites thereof, and reinforced combinations and mixtures and composites thereof. In alternative variations of this embodiment, the rod material 610 is a super-elastic, shape memory metal alloy selected from the group including Nitinol, Hastelloy, Elgiloy, MP35N, Haynes, Inconel, Nimoin, Nispan C, Monel, Waspaloy, Incoloy, 300 series and 400 series stainless steel, and titanium, and alloys, combinations, mixtures, compositions, and hybrids thereof. In yet other modifications, the rod material 610may be formed from a hybrid material, structure, or composition that includes any of the preceding metals and thermoplastics.

In alternatives of any of the preceding embodiments, the adjustable attach device 660 may also be formed from a releasable connection device such as a bayonet end (not shown) adapted to be telescopically and pivotally interconnected to the CPM apparatus 100 by a coupler 520 adapted to enable movement of the finger motion assembly 510 in multiple degrees of freedom relative to the coupler 520.

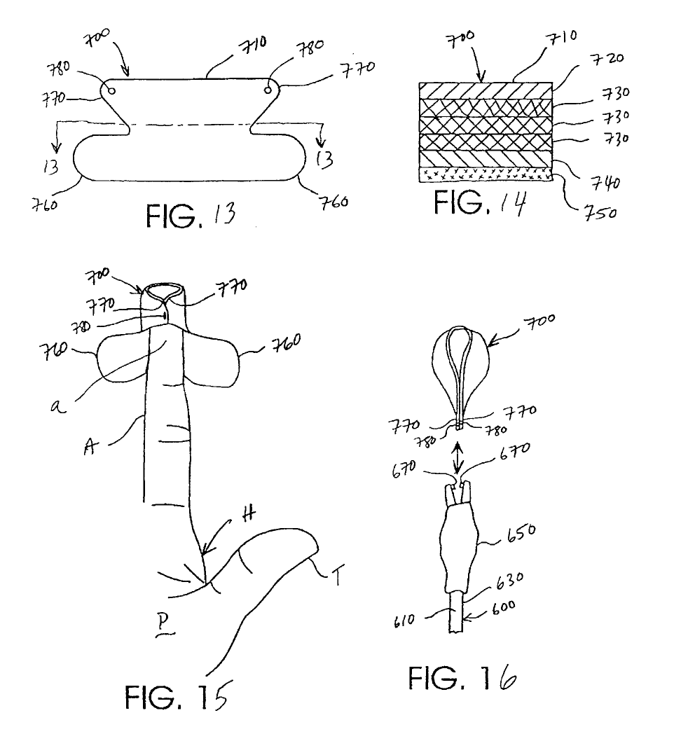

As reference is next directed to FIGS. 13-16, and continuing reference is made to the preceding figures, the finger motion assembly 510 according the preceding illustrative configurations may also further include at least one finger splint 700 adapted to be releasably connected to the finger attachment clip 650 of the finger motion assembly 510. The finger splint 700 may be adapted to receive the distal phalanx “a” of the at least one finger (FIG. 15), such as, for example, finger A. The at least one finger splint 700 is preferably formed from a flexible sheet material 710 that incorporates at least one layer selected from the group including stiffening layer(s) 720, bend memory layer(s) 730, and hypo-allergenic adhesive layer(s) 740. The stiffening layer 720 preferably resiliently stiffens the finger splint 700 to add durability and rigidity. More preferably, the stiffening layer 720 is formed from any suitable plastic and paper films and sheets, that may include, for example but not limitation, polyethylene, polyethylene naphthalate, metallocenes, polypropylene, cellulosic acetal resins, fluorocarbons, polyesters, polyester elastomers, polyamides, vinyl, polyvinyl, nylon, polyvinyl chloride, polybutadienes, silicone resins, ABS, liquid crystal polymers, combinations and mixtures and composites thereof, layups thereof, and reinforced combinations and mixtures and composites thereof.

The bend memory layer 730 preferably is adapted to be laminated to and to preferably overcome the resiliency of the stiffening layer 720 so as to allow the finger splint 700 to be conformally bent around the fingers, and to retain the conformal shape after the bending force is removed. However, a bend memory sufficient to overcome the stiffness of the stiffening layer 720 is optional since the finger splint works well with a bend memory that is too weak to overcome the stiffness. The bend memory layer 730 is also preferably formed from a metallic or thermoplastic sheet material of at least one layer having a bend memory property. More preferably, the sheet material is selected from the group including metallized or metallic papers, plastics (including any of the aforementioned thermoplastic materials), and foils, for example but not limitation, metallic film, aluminum foil, stainless steel foil, and alloys, layups, combinations, compositions, and hybrids thereof. More preferably, the bend memory layer is preferably a thin metallic sheet material of multiple layers.

The hypo-allergenic adhesive layers 740 is preferably adapted to incorporate a biocompatible, water-based permanent adhesive that can adhere to and remain in contact with the dermal layer of the finger for extended periods of recuperative therapy without slipping off the finger and without causing discomfort to the patient during CPM treatment.

One of many suitable components for the bend memory and adhesive layers 730, 740 of the finger splint 700 can be obtained from Acucote, Inc. of Graham, N.C., which offers foil and paper based products including, for example, product model nos. CA40BS and CA40SM, which can be obtained to incorporate a preapplied, water-based, rubber resin adhesive. Other similar products that do not incorporate latex-based rubber resins can also be obtained for even better hypo-allergenic properties. In a preferred configuration, it has been found that 3 bend memory layers that incorporate, for purposes of illustration but not limitation, a metallized paper such as Acucote, Inc. product no. CA40SM, and which are laminated together are suitable for purposes of the present invention. Next, a polypropylene material such as a sheet polypropylene (or any other suitable thermoplastic including those mentioned hereinabove) having a thickness of 0.002 inches can be laminated to the non-adhesive surface of the bend memory layers as reflected best in FIG. 14. An adhesive protective release liner 750 may also be incorporated to protect the adhesive layer 740 until use. One suitable type of coated paper release liner 750 includes a semi-bleached, supercalendered, 40 pound white kraft paper.

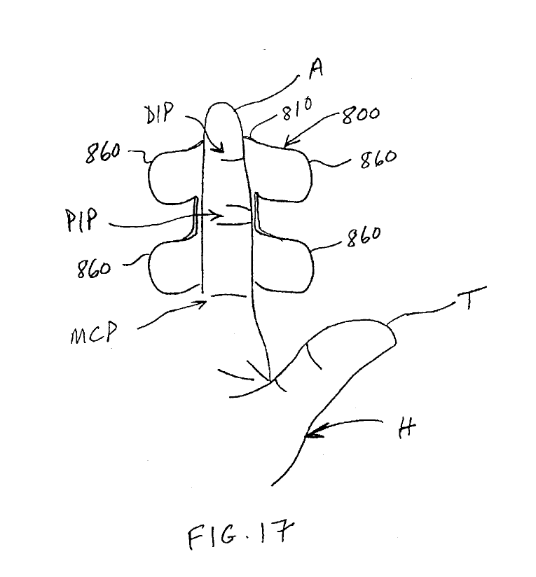

With continued reference specifically to FIGS. 13-16, the flexible sheet material 710 may be formed with a planformal profile that incorporates one or more or a plurality of wrap tabs 760 configured to substantially encircle at least the distal phalanx “a” of the at least one finger A. Although a plurality of wrap tabs is reflected in the various figures, a single extended length wrap is also suitable. A plurality of attachment tabs 770 formed with recesses 780 may also be included. The recesses 780 are positioned to be aligned when the wrap tabs 760 are arranged so as to substantially encircle the at least one finger A, and to pivotally connect the finger splint 700 to the finger attachment clip 650. A suitable method of ensuring an acceptable pivotable connection between the finger clip 650 and the finger splint 700 is depicted in FIG. 16, wherein clip posts 670 are arranged to be received within recesses 780 upon attachment, which enables free pivotal motion.

With reference next to FIG. 17, it can be understood that the present invention also contemplates a finger immobilization splint 800 that is adapted for use with the CPM apparatus 100 disclosed above. The exemplary embodiment of the finger immobilization splint 800 is adapted to immobilize at least one joint of a finger of a patient's hand, which as depicted in FIG. 17 for purposes of illustration but not limitation, include the DIP and PIP joints. The immobilization splint 800 preferably includes a construction that is similar to that of the aforementioned finger splint 700, and preferably includes one or more or a plurality of finger wrap tabs 860.

The immobilization splint 800, does not necessarily require attachment tabs, such as attachment tabs 770, but it may include them for purposes of, for example, immobilizing the DIP and PIP joints while mobilizing the MCP joint. If an entire finger is to be immobilized, then the apparatus 100 may exclude a corresponding finger motion assembly 510. If a certain finger joint is to be immobilized while others are to be treated with CPM, then the finger motion assembly 510 and specifically primer mover 600 may be adjusted accordingly.

Preferably, the immobilization splint 800 is made from a substantially similar construction to that of the finger splint 700 described above. The single or plurality of wrap tabs 860 that are formed in the sheet 810 and configured to substantially encircle at least one joint, such as the DIP, PIP, or MCP joints, of the at least one finger A. When installed, the at least one joint is thereby immobilized as each of the plurality of wrap tabs 860 substantially encircles the at least one finger A and thereby prevents the finger A from being flexed about that joint, or about those joints. The finger immobilization splint 800 may be constructed in the same fashion and using the same types of materials already described in connection with the finger splint 700.

Numerous alterations, modifications, and variations of the exemplary configurations are disclosed herein and many more will be apparent to those skilled in the art, and all are contemplated by the instant invention. For example, although specific embodiments have been described in detail, those with skill in the art will understand that the preceding embodiments and variations can be modified to incorporate various types of substitute and/or additional materials and components, relative arrangement of elements, and modified dimensional configurations for compatibility with the wide variety of CPM recuperative therapies directed to many types of body parts. The multidimensional degrees of freedom demonstrated by the present invention, which, among many other benefits, enables optimized configurations for improved compatibility with a wider range of potential patient anatomies, is a concept that can be incorporated into designs for CPM devices operable for treatment of various body parts including, for example, the neck, hips, legs, knees, ankles, feet, toes, shoulders, elbows, and wrists. Accordingly, even though only few exemplary configurations and variations of the present invention are described herein, it is to be understood that the practice of such additional modifications and variations and the equivalents thereof, are all within the spirit and scope of the invention as defined in the following claims.

I claim:

1. A continuous passive motion apparatus for therapeutic treatment of at least one finger of a patient's hand, comprising:
a drive unit, adapted to be carried from a palmer aspect of a hand splint adapted to be worn about a forearm of the patient proximate to the hand, and incorporating a motor driven drive tube actuatable over a selectable range of motion;
a flexion and extension assembly connected to the drive tube and including at least one finger motion assembly pivotally interconnected to a proximal end of the drive tube by a quaternion coupler adapted to enable movement of the finger motion assembly in at least 2 degrees of freedom relative to the coupler; and
at least one finger splint releasably connected to a distal end of the finger motion assembly and adapted to receive a distal phalanx of the at least one finger, the finger splint being formed from a flexible sheet material that incorporates layers selected from the group including stiffening, bend memory, and hypo-allergenic adhesive layers.

2. The continuous passive motion apparatus according to claim 1, wherein the quaternion coupler is further adapted to enable movement of the finger motion assembly in at least 3 degrees of freedom relative to the coupler.

3. The continuous passive motion apparatus according to claim 1, wherein the quaternion coupler is further adapted to enable movement of the finger motion assembly in at least 4 degrees of freedom relative to the coupler.

4. The continuous passive motion apparatus according to claim 1, wherein the quaternion coupler is further adapted to releasably engage the finger motion assembly after adjustment to accommodate the anatomical arrangement, size, and range and path of motion of the at least one finger.

5. A continuous passive motion apparatus for therapeutic treatment of at least one finger of a patient's hand, comprising:
a drive unit, adapted to be carried from a palmer aspect of a hand splint adapted to be worn about a forearm of the patient proximate to the hand, and incorporating a motor driven drive tube actuatable over a selectable range of motion;
a flexion and extension assembly connected to the drive tube and including at least one finger motion assembly pivotally interconnected to a proximal end of the drive tube by a coupler adapted to enable movement of the finger motion assembly in multiple degrees of freedom relative to the hand splint; and
at least one finger splint releasably connected to a distal end of the finger motion assembly and adapted to receive a distal phalanx of the at least one finger and being formed from a flexible sheet material that incorporates a combination of layers selected from the group including stiffening, bend memory, and hypo-allergenic adhesive layers.

6. The continuous passive motion apparatus according to claim 5, wherein the finger motion assembly is further adapted to enable movement of the finger motion assembly in at least 3 degrees of freedom relative to the hand splint.

7. The continuous passive motion apparatus according to claim 5, wherein the finger motion assembly is further adapted to enable movement of the finger motion assembly in at least 4 degrees of freedom relative to the hand splint.

8. The continuous passive motion apparatus according to claim 5, wherein the coupler is further adapted to releasably engage the finger motion assembly after adjustment to accommodate the anatomical arrangement, size, and range and path of motion of the at least one finger.

9. A continuous passive motion apparatus for therapeutic treatment of at least one finger of a patient's hand, comprising:
a drive unit, adapted to be carried from a palmer aspect of a hand splint adapted to be worn about a forearm of the patient proximate to the hand, and incorporating a motor driven drive tube actuatable over a selectable range of motion;
at least one finger motion assembly connected to a proximal end of the drive tube and adapted with a coupler that enables movement of the finger motion assembly in at least 2 degrees of freedom relative to the hand splint; and,
at least one finger splint releasably connected to a distal end of the finger motion assembly and adapted to receive a distal phalanx of the hand and being formed from a flexible sheet material that incorporates at least one layer having a surface treated with a hypo-allergenic adhesive.

10. The continuous passive motion apparatus according to claim 9, wherein the finger motion assembly is pivotally interconnected by the coupler, which is further adapted to enable movement of the finger motion assembly in at least 3 degrees of freedom relative to the coupler.

11. The continuous passive motion apparatus according to claim 9, wherein the finger motion assembly is pivotally interconnected by the coupler, which is farther adapted to enable movement of the finger motion assembly in at least 4 degrees of freedom relative to the coupler.

12. The continuous passive motion apparatus according to claim 9, wherein the finger motion assembly is pivotally interconnected by the coupler, which is further adapted to releasably engage the finger motion assembly after adjustment to accommodate the anatomical arrangement, size, and range and path of motion of the at least one finger of the patient's hand.

13. A continuous passive motion apparatus for therapeutic treatment of at least one finger of a patient's hand, comprising:
a drive unit, adapted to be earned from a palmer aspect of a hand splint adapted to be worn about a forearm of the patient proximate to the hand, and incorporating a motor driven drive tube actuatable over a selectable range of motion;
a flexion and extension assembly connected to the drive tube and including at least one finger motion assembly pivotally interconnected to a proximal end of the drive tube by a quaternion coupler adapted to enable movement of the finger motion assembly in at least 4 degrees of freedom relative to the coupler, and wherein the finger motion assembly is pivotally interconnected by the coupler which is further adapted to releasably engage the finger motion assembly after adjustment to accommodate the anatomical arrangement, size, and range and path of motion of the at least one finger; and
at least one finger splint releasably connected to a distal end of the finger motion assembly and adapted to receive a distal phalanx of the at least one finger and being formed from a flexible sheet material that incorporates layers selected from the group including stiffening, bend memory, and hypo-allergenic adhesive layers.

14. A continuous passive motion apparatus for therapeutic treatment of the fingers of a patient's hand, comprising
a drive unit, adapted to be carried from a palmer aspect of a hand splint adapted to be worn about a forearm of the patient proximate to the hand, and incorporating a motor driven drive tube actuatable over a selectable range of motion;
a flexion and extension assembly connected to the drive tube and including at least 4 finger motion assemblies each pivotally interconnected to a proximal end of the drive tube by a coupler adapted to enable movement of each finger motion assembly in at least 4 degrees of freedom relative to the coupler, and wherein each finger motion assembly is pivotally interconnected by the coupler which is further adapted to releasably engage the at least 4 finger motion assemblies after adjustment to accommodate the anatomical arrangement, size, and range and path of motion of the fingers; and
at least one finger splint releasably connected to a distal end of each of the finger motion assemblies and adapted to receive a different distal phalanx of the fingers and being formed from a flexible sheet material that incorporates layers selected from the group including stiffening, bend memory, and hypo-allergenic adhesive layers.

15. A finger motion assembly for use with a continuous passive motion apparatus and for therapeutic treatment of at least one finger of a patient's hand, comprising:
a resilient prime mover formed from a rod material selected to be repeatedly bendable without damage and to have a bend memory and material property that withstands repetitive tensile, compressive, and shear loads;
wherein the prime mover is further formed to have, as measured between proximal and distal ends, an acute angle of approximately between 0 and 90 degrees;
an adjustable and releasable finger attachment clip about the distal end, and adapted to receive the at least one finger; and
an adjustable attach device about the proximal end that is configured for adjustment in at least 2 degrees of freedom, and for connection to and actuation by the continuous passive motion apparatus.

16. The finger motion assembly according to claim 15, wherein the rod material is selected from the group including powdered, machined, drawn, stamped, rolled, extruded, and forged thermoplastics, and super-elastic, shape memory metals, alloys, and combinations, structures, mixtures, compositions, and hybrids thereof.

17. The finger motion assembly according to claim 15, wherein the rod material is a thermoplastic material selected from the group including acetal resins, delrin, fluorocarbons, polyesters, polyester elastomers, metallocenes, polyamides, nylon, polyvinyl chloride, polybutadienes, silicone resins, ABS, polypropylene, liquid crystal polymers, combinations and mixtures and composites thereof, and reinforced combinations and mixtures and composites thereof.

18. The finger motion assembly according to claim 15, wherein the rod material is a super-elastic, shape memory metal alloy selected from the group including Nitinol, Hastelloy, Elgiloy, MP35N, Haynes, Inconel, Nimoin, Nispan C, Monel, Waspaloy, Incoloy, 300 series and 400 series stainless steel, and titanium, and alloys, combinations, structures, mixtures, compositions, and hybrids thereof.

19. The finger motion assembly according to claim 15, wherein the adjustable attach device incorporates a threaded end adapted to be threadably and pivotally interconnected to the continuous passive motion apparatus by a coupler adapted to enable movement of the finger motion assembly in multiple degrees of freedom relative to the coupler.

20. The finger motion assembly according to claim 19, wherein the coupler is further adapted to releasably engage the finger motion assembly after adjustment to accommodate the anatomical arrangement, size, and range and path of motion of the at least one finger during operation of the continuous passive motion apparatus.

21. The finger motion assembly according to claim 15, wherein the adjustable attach device incorporates a bayonet end adapted to be telescopically and pivotally interconnected to the continuous passive motion apparatus by a coupler adapted to enable movement of the finger motion assembly in multiple degrees of freedom relative to the coupler.

22. The finger motion assembly according to claim 21, wherein the coupler is further adapted to releasably engage the finger motion assembly after adjustment to accommodate the anatomical arrangement, size, and range and path of motion of the at least one finger during operation of the continuous passive motion apparatus.

23. The finger motion assembly according to claim 15, further comprising:
at least one finger splint releasably connected to the finger attachment clip and adapted to receive the distal phalanx of the at least one finger, the at least one finger splint being formed from a flexible sheet material that incorporates layers selected from the group including stiffening, bend memory, and hypo-allergenic adhesive layers.

24. The finger motion assembly according to claim 23, wherein the flexible sheet material is formed with a planformal profile to have a plurality of wrap tabs configured to substantially encircle at least the distal phalanx of the at least one finger; and
a plurality of attachment tabs arranged to be aligned when the wrap tabs are arranged so as to substantially encircle the at least one finger, and when so aligned, to be connected to the finger attachment clip.

25. A flexion and extension actuator assembly for use with a continuous passive motion apparatus adapted for therapeutic treatment of at least one finger of a patient's hand, comprising:
a coupler adapted to be driven and actuated by the continuous passive motion apparatus;
at least one pivot ball received within the coupler and configured to move about multiple axes of motion;
a finger motion assembly that includes an adjustably bendable rod with a proximal end that has an adjustable attach device configured to move about multiple at axes of motion relative to the coupler; and
wherein the pivot ball is adapted to be releasably constrained within the coupler whereby the finger motion assembly can be adjusted to optimally conform to the respective anatomical size, arrangement, and range and path of motion of the patient's at least one finger and hand.

26. The flex ion and extension actuator assembly according to claim 25, wherein the attach device incorporates a threaded end adapted to be threadably and pivotally interconnected to the coupler to enable adjustment of the finger motion assembly in multiple degrees of freedom relative to the coupler.

27. The finger motion assembly according to claim 28, wherein the coupler is further adapted to releasably engage the finger motion assembly after adjustment to accommodate the anatomical arrangement, size, and range and path of motion of the at least one finger during operation of the continuous passive motion apparatus.

28. The finger motion assembly according to claim 25, wherein the adjustable attach device incorporates a bayonet end adapted to be telescopically and pivotally interconnected to the coupler to enable adjustment of the finger motion assembly in multiple degrees of freedom relative to the coupler.

29. The finger motion assembly according to claim 28, wherein the coupler is further adapted to releasably engage the finger motion assembly after adjustment to accommodate the anatomical arrangement, size, and range and path of motion of the at least one finger during operation of the continuous passive motion apparatus.

30. The finger motion assembly according to claim 25, further comprising:
at least one finger splint releasably connected to a finger attachment clip on the distal end of the rod and adapted to receive the distal phalanx of the at least one finger, the at least one finger splint being formed from a flexible sheet material that incorporates layers selected from the group including stiffening, bend memory, and hypo-allergenic adhesive layers.

31. The finger motion assembly according to claim 30, wherein the flexible sheet material is formed with a planformal profile to have a plurality of wrap tabs configured to substantially encircle at least the distal phalanx of the at least one finger; and
a plurality of attachment tabs arranged to be aligned when the wrap tabs are arranged so as to substantially encircle the at least one finger.

32. A finger splint adapted for use with a continuous passive motion apparatus and to receive a distal end of at least one finger of a patient's hand, comprising:
a substantially planar flexible sheet material that incorporates a resilient stiffening layer, a bend memory layer, a hypo-allergenic adhesive layer, and a releasable adhesive protective liner;
a plurality of wrap and attachment tabs formed in the sheet and configured to substantially encircle at least the distal phalanx of the at least one finger; and
wherein each of the plurality of attachment tabs is formed with a recess, the recesses being arranged to be aligned when the finger is received within the splint whereby the splint pivotally connects to the continuous passive motion apparatus about the aligned recesses.

33. The finger splint according to claim 32, wherein the resilient stiffening layer is a thermoplastic sheet material selected from the group including plastic and paper films and sheets, polyethylene, polyethylene naphthalate, metallocenes, polypropylene, cellulosic acetal resins, fluorocarbons, polyesters, polyester elastomers, polyamides, vinyl, polyvinyl, nylon, polyvinyl chloride, polybutadienes, silicone resins, ABS, liquid crystal polymers, combinations and mixtures and composites thereof, layups thereof, and reinforced combinations and mixtures and composites thereof.

34. The finger splint according to claim 32, wherein the bend memory layer is a metallic sheet material of at least one layer selected from the group including metallized paper and thermoplastic and foil, metallic foil, metallic film, aluminum foil, stainless steel foil, and alloys, layups, combinations, structures, compositions, and hybrids thereof.

35. The finger splint according to claim 32, wherein the hypo-allergenic adhesive layer is a biologically compatible and releasable adhesive selected from the group including water based rubber resins and water based non-rubber resins.

36. The finger splint according to claim 32, wherein the releasable adhesive protective liner is selected from the group including coated papers and plastics, kraft paper, polycoated paper and plastic liners, and silicone coated paper and plastic liners.

37. A finger immobilization splint adapted for use with a continuous passive motion apparatus and to immobilize at least one joint of a finger of a patient's hand, comprising:
a substantially planar flexible sheet material that incorporates a resilient stiffening layer, a bend memory layer, a hypo-allergenic adhesive layer, and a releasable adhesive protective liner;
a plurality of wrap tabs formed in the sheet and configured to substantially encircle at least one joint of the at least one finger; and
whereby the at least one joint is immobilized when each of the plurality of wrap tabs substantially encircles the at least one finger.

38. The finger immobilization splint according to claim 37, wherein the resilient stiffening layer is a thermoplastic sheet material selected from the group including plastic and paper films and sheets, polyethylene, polyethylene naphthalate, metallocenes, polypropylene, cellulosic acetal resins, fluorocarbons, polyesters, polyester elastomers, polyamides, vinyl, polyvinyl, nylon, polyvinyl chloride, polybutadienes, silicone resins, ABS, liquid crystal polymers, combinations and mixtures and composites thereof, layups thereof, and reinforced combinations and mixtures and composites thereof.

39. The finger immobilization splint according to claim 37, wherein the bend memory layer is a metallic sheet material of at least one layer selected from the group including metallized paper and thermoplastic and foil, metallic foil, metallic film, aluminum foil, stainless steel foil, and alloys, lay-ups, combinations, structures, compositions, and hybrids thereof.

40. The finger immobilization splint according to claim 37, wherein the hypo-allergenic adhesive layer is a biologically compatible and releasable adhesive selected from the group including water based rubber resins and water based non-rubber resins.

41. The finger immobilization splint according to claim 37, wherein the releasable adhesive protective liner is selected from the group including coated papers and plastics, kraft paper, polycoated paper and plastic liners, and silicone coated paper and plastic liners.

42. A continuous passive motion apparatus for therapeutic treatment of at least one finger of a patient's hand, comprising:
a drive unit, adapted to be carried from a palmer aspect of a hand splint adapted to be worn about a forearm of the patient proximate to the hand, and father adapted to drive a flexion and extension assembly adapted to mobilize the at least one finger, and incorporating a motor driven drive tube actuatable over a selectable range of motion; and control electronics that include a ladder logic switching circuit having at least one relay and a plurality of limit and contact switches in electronic communication with the control electronics and the motor and operative to reversibly actuate the motor to move the drive tube over the selectable range of motion; and
wherein the control electronics draw power only during a period of time during which the direction of operation of the motor is reversed by the control electronics.

43. A continuous passive motion apparatus for therapeutic treatment of at least one finger of a patient's hand, comprising:
a drive unit, adapted to be carried from a palmer aspect of a hand splint adapted to be worn about a forearm of the patient proximate to the hand, and incorporating a motor driven drive tube actuatable over a selectable range of motion;
a flexion and extension assembly connected to the drive tube and including at least one finger motion assembly pivotally interconnected to a proximal end of the drive tube by a quaternion coupler adapted to enable movement of the finger motion assembly in at least 2 degrees of freedom relative to the coupler;
control electronics that include a ladder logic switching circuit having a single latch coil relay and a plurality of limit and contact switches in electronic communication with the control electronics and the motor and operative to reversibly actuate the motor to move the drive tube over the selectable range of motion; and
wherein the control electronics draw power only during a period of time during which the direction of operation of the motor is reversed by the control electronics.

44. A continuous passive motion apparatus for therapeutic treatment of at least one finger of a patient's hand, comprising:
a drive unit, adapted to be carried from a palmer aspect of a hand splint adapted to be worn about a forearm of the patient proximate to the hand, and further adapted to drive a flexion and extension assembly adapted to mobilize the at least one finger, and incorporating a motor driven drive tube actuatable over a selectable range of motion that is selected by a range of motion adjuster; and
control electronics that include a ladder logic switching circuit having at least one relay and a plurality of limit and contact switches in electronic communication with the control electronics and the motor and operative to reversibly actuate the motor to move the drive tube over the selectable range of motion; and
wherein the control electronics draw power only during a period of time during which the direction of operation of the motor is reversed by the control electronics.
